(19) United States
(12) Patent Application Publication
(10) Pub. No.: US 2007/0227902 A1
(43) Pub. Date: Oct. 4, 2007

(54) Removal profile tuning by adjusting conditioning sweep profile on a conductive pad

(75) Inventors: Tianbao Du, Santa Clara, CA (US); Feng Q. Liu, San Jose, CA (US); May Yu, Fremont, CA (US); Alain Duboust, Sunnyvale, CA (US); Wei-Yung Hsu, Santa Clara, CA (US)

Correspondence Address: PATTERSON & SHERIDAN, LLP, 3040 POST OAK BOULEVARD, SUITE 1500, HOUSTON, TX, 77056, US

(73) Assignee: Applied Materials, Inc.

(21) Appl. No.: 11/392,193

(22) Filed: Mar. 29, 2006

(51) Int. Cl. B23H 5/08

(52) U.S. Cl. 205/663

(57) ABSTRACT

A method for controlling the removal rate of material from a substrate during a polishing process is described. In one embodiment, the pre-polish profile of the substrate is determined and polishing pad conditioning parameters are adjusted based on that profile. Parameters such as conditioning head sweep range and frequency, and conditioning element downforce and RPM may be adjusted to selectively condition portions of the pad to maintain optimum polishing qualities of the pad.

### BACKGROUND OF THE INVENTION

1. Field of the Invention

Embodiments of the invention generally relate to removing material from a substrate. More particularly, the invention relates to polishing or planarizing a substrate by electrochemical mechanical polishing.

2. Description of the Related Art

In the manufacture of integrated circuits, layers of conductive material are sequentially deposited on a semiconductor wafer and removed to produce a desired circuit on the wafer.

Electrochemical Mechanical Processing (ECMP) is a technique used to remove conductive materials from a semiconductor wafer or substrate surface by electrochemical dissolution while concurrently polishing the substrate with reduced downforce and mechanical abrasion as compared to conventional Chemical Mechanical Polishing (CMP) processes. Electrochemical dissolution is typically performed by applying a bias to the substrate surface performing as an anode, and applying a bias to a cathode to remove conductive materials from the substrate surface into a surrounding electrolyte. The bias may be applied to the substrate surface by a conductive material disposed on, or a conductive contact disposed on or through, a polishing material upon which the substrate is processed. The polishing material may be, for example, a processing pad disposed on a platen. A mechanical component of the polishing process is performed by providing relative motion between the substrate and the polishing material that enhances the removal of the conductive material from the substrate. ECMP systems may generally be adapted for deposition of conductive material on the substrate by reversing the polarity of the bias applied between the substrate and an electrode.

The substrate typically begins the planarization process having bulk conductive material deposited thereon in a non-planar orientation, which may be removed by one or more ECMP processes. When more than one ECMP process is utilized, the bulk removal is designed to produce a high removal rate and produce a substrate surface that is substantially planar before going to the next ECMP process. In some ECMP processes, various chemistries have been developed to promote a higher removal rate of conductive material with lower downforce applied to the substrate. For example, passivation chemistry promotes a higher removal rate on raised areas of the substrate surface by passivating the conductive material on recessed areas of the substrate, thereby producing a more planar surface after the bulk removal process.

The processing pad performing this bulk removal must have the appropriate mechanical properties for substrate planarization while minimizing the generation of defects in the substrate during polishing. Such defects may be scratches in the substrate surface caused by raised areas of the pad or by polishing by-products disposed on the surface of the pad, such as accumulation of conductive material removed from the substrate precipitating out of the electrolyte solution, abraded portions of the pad, agglomerations of abrasive particles from a polishing slurry, and the like. The polishing potential of the processing pad generally lessens during polishing due to wear and/or accumulation of polishing by-products on the pad surface, resulting in sub-optimum polishing qualities. This sub-optimization of the polishing pad may occur in a non-uniform or localized pattern across the pad surface, which may promote uneven planarization of the conductive material. Thus, the pad surface must periodically be refreshed, or conditioned, to restore the polishing performance of the pad.

While sub-optimization of the polishing potential of the pad may occur non-uniformly on the pad surface, a pad conditioning regime is typically implemented in a uniform manner across the pad surface. This uniform conditioning regime thus conditions the pad indiscriminately, which may result in an improvement of the polishing potential of the pad. However, the uniform pad conditioning regime neither accounts for areas of the pad exhibiting a localized loss in the polishing potential, nor areas of the pad that exhibit little or no decrease in polishing potential. Thus, optimum conditions may be maintained on portions of the pad where little or no decrease in polishing potential occurred, while localized portions where there is a higher decrease in polishing potential may remain sub-optimum.

Therefore, there is a need for an improved method for conditioning processing pads.

### SUMMARY OF THE INVENTION

Embodiments of the invention generally provide a method of processing a semiconductor substrate which includes determining an incoming thickness profile of the substrate, setting conditioning parameters in response to the thickness profile, and conditioning a processing surface of a polishing pad using the conditioning parameters.

In another embodiment, a method of processing a semiconductor substrate is described which includes determining a metric indicative of an incoming thickness profile of a conductive material on the substrate, and changing an electrical property on a processing surface of a polishing pad in response to the metric.

In another embodiment, a method of processing a semiconductor substrate is described which includes determining an incoming thickness profile of a conductive material on the substrate, setting one or more conditioning parameters based on the thickness profile, processing the substrate against a polishing surface of a polishing pad to perform a first polishing process, and conditioning the processing surface using the conditioning parameters while performing the first polishing process.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is one embodiment of a processing system.

FIG. 2 is an exploded isometric view of one embodiment of a pad assembly.

FIG. 3 is a schematic side view of one embodiment of an ECMP station.

FIG. 4 is a schematic top view of another embodiment of an ECMP station.

FIG. 5 is one embodiment of a polishing method.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the invention generally relate to polishing or planarizing processes performed in the production of semiconductor substrates. Electrochemical Mechanical Planarization (ECMP) is one of the polishing processes described and broadly includes removal of previously deposited material from the semiconductor surface by a combination of mechanical, chemical, and/or electrochemical forces. The mechanical force may include, but is not limited to, physical contact or rubbing action, and the chemical and/or electrical forces may include, but are not limited to, removal of material by anodic dissolution.

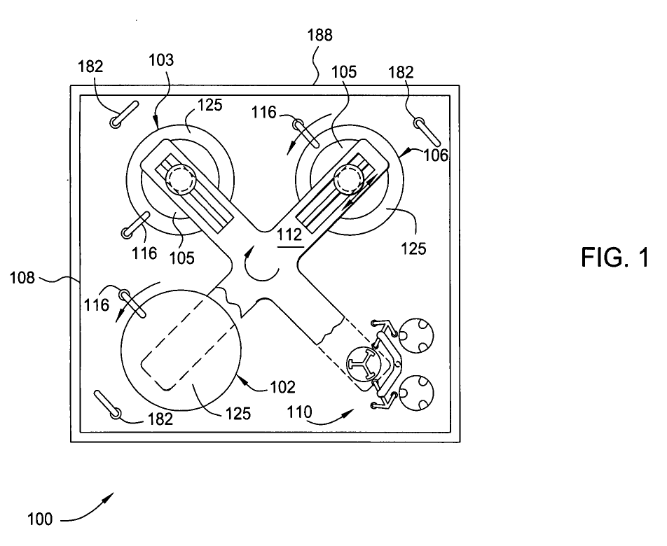

FIG. 1 is a plan view of a portion of a processing system 100 having a planarizing module that is suitable for electrochemical mechanical polishing and chemical mechanical polishing. The processing system 100 includes at least a first electrochemical mechanical planarization (ECMP) station 102, a second ECMP station 103, and optionally, at least one conventional chemical mechanical planarization (CMP) station 106 disposed in an environmentally controlled enclosure 188. In one exemplary process, a substrate having feature definitions formed therein and filled with a barrier layer and then a conductive material disposed over the barrier layer may have the conductive material removed in two steps in the two ECMP stations 102, 103, with the barrier layer processed in the CMP station 106 to form a planarized surface on the substrate. For example, the first ECMP station 102 may perform a first polishing step, for example a bulk removal step, the second ECMP station 103 may perform a second polishing step, for example a residual polishing step, and the CMP station 106 may perform a third polishing step, for example a barrier removal step. It is to be understood that the invention is not limited to this configuration and that all of the stations 102, 103, and 106 may be adapted to use an ECMP process to remove various layers deposited on the substrate. Alternatively, the processing system 100 may include two stations that are adapted to perform a CMP process while another station may perform an ECMP process. It is to be noted that the stations 102, 103, and 106 in any of the combinations mentioned above may also be adapted to deposit a material on a substrate by an electrochemical and/or an electrochemical mechanical plating process.

An example of ECMP stations that may be adapted to benefit from aspects of the invention are described in U.S. Pat. No. 6,244,935 (Attorney Docket No. 003486), which issued Jun. 12, 2001, and U.S. patent application Ser. No. 10/880,752 (Attorney Docket No. 004100.P11), filed Jun. 30, 2004, both of which are incorporated herein by reference to the extent the disclosures are not inconsistent with this disclosure. An example of a processing system that may be adapted to practice the invention is the REFLEXION LK Ecmp™ system available from Applied Materials, Inc. located in Santa Clara, California. Other planarizing modules commonly used in the art may also be adapted to practice the invention.

The first ECMP station 102, the second ECMP station 103, and the CMP station 106, all have a nozzle 116 for delivery of a fluid to the processing surface 125 and a conditioning apparatus 182 rotatably attached to a base 108. The processing system 100 also includes a carousel 112 and a transfer station 110 disposed on the base 108. The carousel 112 generally supports a plurality of carrier heads 105, each of which retains one substrate during processing. The carousel 112 articulates the carrier heads 105 between the transfer station 110 and stations 102, 103, and 106. The carrier heads 105 are adapted to controllably press the substrate against a processing surface 125 when the carrier head is disposed above each of the stations 102, 103, and 106.

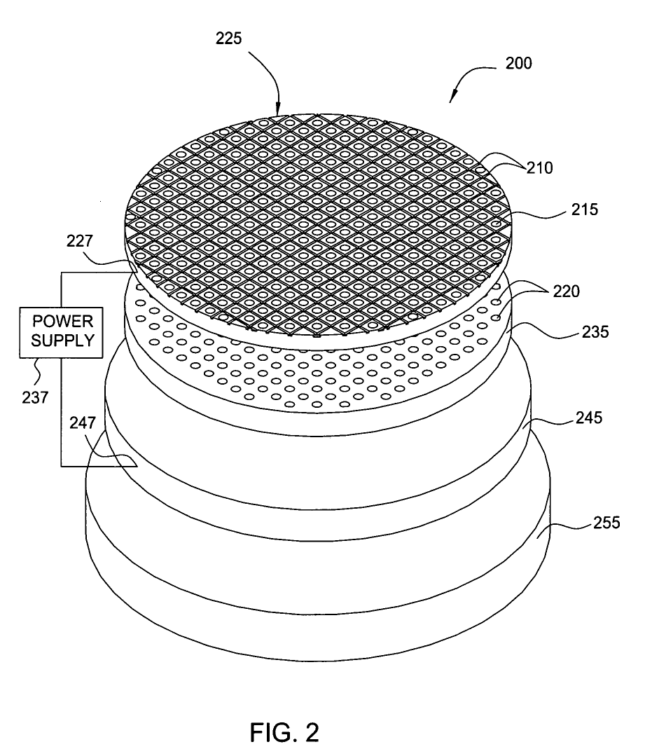

FIG. 2 is an exploded isometric view of a pad assembly 200 having a conductive processing surface 225 disposed on an electrode 245, with a sub-pad 235 therebetween. In this embodiment, the conductive processing surface 225 defines the processing surface 125 of the ECMP station 102 shown in FIG. 1. The conductive processing surface 225 and the electrode 245 include at least one connector 227, 247, respectively, to couple the pad assembly 200 to opposing poles of a power source 237. The sub-pad 235 provides enhanced compressibility to the conductive processing surface 225 and functions as an insulation element between the two conductive portions to allow the conductive processing surface to act as an anode, and the electrode 245 to function as a cathode in the ECMP process. The electrode 245 may be a solid metal sheet, a foil, or mesh made of gold, tin, nickel, silver, stainless steel, derivatives thereof and combinations thereof. The various parts of the pad assembly 200 are typically coupled together by a process compatible adhesive, and is removably attached to an upper surface of a platen assembly 255, which is disposed within one or both of the ECMP stations 102, 103 of FIG. 1.

The conductive processing surface 225 may be made of a conductive material and/or comprise conductive particles bound in a polymer matrix. For example, conductive material may be dispersed integrally with or comprise the material comprising the processing surface 225, such as a polymer matrix having conductive particles dispersed therein and/or a conductive coated fabric, among others. The conductive particles may be particles of metal, such as gold, nickel, tin, zinc, copper, derivatives and combinations thereof. The conductive polymer may be disposed on a conductive carrier that may be a conductive foil or mesh. The conductive processing surface 225 may also include one or more apertures 215 that at least partially align with holes 220 in the sub-pad 235. The apertures 215 and the holes are adapted to be filled with an electrolyte to permit electrolytic communication between the electrode and the substrate surface when the conductive processing surface 225 is pressed against the conductive material on the substrate. Grooves or channels 210 may be formed on the conductive processing surface 225 to enhance electrolyte flow and retention, and provide a pathway for materials removed from the substrate to be flushed from the processing surface. Examples of pad assemblies may be found in U.S. patent No. 6,991,528 (Attorney Docket No. 004100.P4), which issued Jan 31, 2006, U.S. application No. 10/744,904 (Attorney Docket No. 004100.P10), filed Dec. 23, 2003. Both the patent and application are hereby incorporated by reference to the extent the disclosures are not inconsistent with this application.

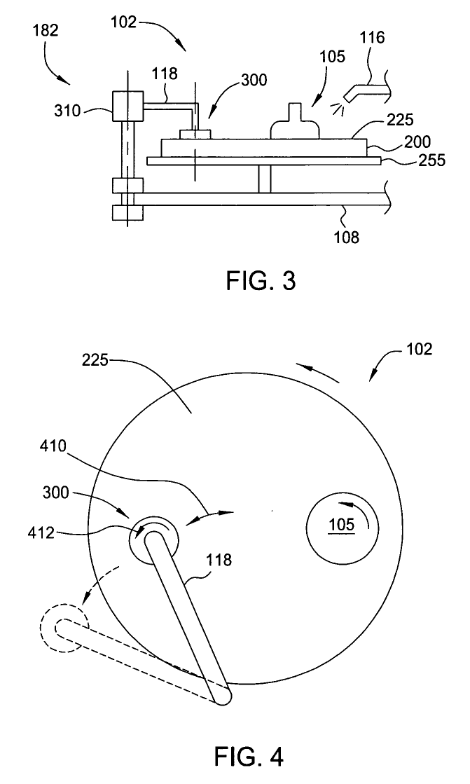

FIG. 3 is a schematic side view of an ECMP station 102 of an ECMP system. The polishing station 102 generally includes a conditioning apparatus 182 and a platen 255 rotated by a motor (not shown). The pad assembly 200 is disposed on the upper surface of the platen 255 such that the conductive processing surface 225 defines the processing surface 125 of the ECMP station 102. A carrier head 105 is disposed above the pad assembly 200 and is adapted to hold a substrate against the pad assembly 200 during processing. The carrier head 102 may impart a portion of the relative motion provided between the substrate and the pad assembly 200 during processing. In one embodiment, the carrier head 102 may be a TITAN HEAD™ or TITAN PROFILER™ wafer carrier available from Applied Materials, Inc., of Santa Clara, California. A processing fluid, such as an electrolyte, may be provided to the processing surface of the pad assembly 200 by a nozzle 116 coupled to a processing fluid source (not shown).

The conditioning apparatus 182 comprises a conditioning head 300 supported by a support assembly 310 with a support arm 118 therebetween. The support assembly 310 is coupled to the base 108 and is adapted to position the conditioning head 300 in contact with the pad assembly 200, and further is adapted to provide a relative motion therebetween. The conditioning head 300 is also configured to provide a controllable pressure or downforce to controllably press the conditioning head toward the pad assembly 200. The downforce pressure can be in a range between about 0.7 psi to about 2 psi. The conditioning head 300 generally rotates and/or moves laterally in a sweeping motion across the surface of the pad assembly 200 as indicated by arrows 410 and 412 in FIG. 4. In one embodiment, the lateral motion of the conditioning head 300 may be linear or along an arc in a range of about the center of the pad assembly 200 to about the outer edge of the pad assembly 200, such that, in combination with the rotation of the pad assembly 200, the entire surface of the pad assembly 200 may be conditioned. The conditioning head 300 may have a further range of motion to move the conditioning head 300 beyond the edge of the pad assembly 200 when not in use (as shown in phantom in FIG. 4).

The conditioning head 300 is adapted to house a conditioning element (not shown) to contact the pad assembly 200. The conditioning element generally extends beyond the housing of the conditioning head 300 by about 0.2 mm to about 1 mm in order to contact the upper surface of the pad assembly 200. The conditioning element can be made of nylon, cotton cloth, polymer, or other soft material that will not damage the upper surface of the pad assembly 200. Alternatively, the conditioning element may be made of a textured polymer or stainless steel having a roughened surface with diamond particles adhered thereto or formed therein. The diamond particles may range in size between about 30 microns to about 100 microns. Suitable conditioning elements are 3 M™ Diamond Pad Conditioners and conditioning discs from the Kinik Co. of Taipei, Taiwan.

FIG. 4 is a schematic top view of an ECMP station 102 of an ECMP system. The conditioning head is shown coupled to the support arm 118 and the range of motion across the upper surface of the pad assembly 200 is shown by arrow 410. In one embodiment, the sweep range is from a perimeter portion of the pad to the center portion of the pad, i.e., the sweep range is a radial sweep range as the range enables conditioning of a radius of the pad. In other embodiments the sweep range is less than the radial sweep range by some fraction of one. In another embodiment, the sweep range may be greater than the radial sweep range.

Generally, the incoming or pre-polish profile of a substrate includes a greater height and/or thickness of conductive material, which includes copper containing materials, over narrow feature definition areas relative to areas of the substrate which have wide feature definitions. Further, the pre-polish profile may include higher and/or thicker areas of conductive material along the edge of the substrate relative to the center of the substrate.

In an electromechanical chemical polishing step, the substrate is exposed to an electrolyte containing passivation agents to form a passivation layer on the conductive material of the substrate to inhibit anodic dissolution of the conductive material. The passivation layer is contacted with a polishing article during mechanical polishing to remove the passivation layer from areas of greater height and/or thickness while allowing the passivation layer to be retained in areas of lesser height, such as over wide feature definitions. A bias applied to the substrate results in anodic dissolution to be performed without inhibition at areas of the conductive material where the passivation layer is removed, and such areas are preferentially removed compared to the areas of lesser height to planarize the conductive material. Removal of conductive material by an ECMP process may still result in dishing within wide feature definitions.

A protrusion formation ECMP process may be used to limit or minimize dishing within wide feature definitions. In an ECMP process, a protrusion formation composition and/or protrusion formation power application may be used to decrease removal of material over wide feature definitions to an extent that an ample height and/or thickness of conductive material remains over the wide feature definitions as compared to narrow feature definitions. Formation of the protrusion of conductive materials over wide feature definitions allows for subsequent processes to be performed, which conventionally remove material over wide feature definitions at removal rates faster than narrow feature definitions, to be used to planarize the conductive material with minimal or no dishing within wide feature definitions.

Examples of a protrusion formation process are further detailed in U.S. patent application No. XX/XXX,XXX (Attorney Docket No. 005699.P9), filed Feb. 15, 2006, entitled “METHOD AND COMPOSITION FOR POLISHING A SUBSTRATE,” and U.S. patent application Ser. No. 10/608,404 (Attorney Docket No. 005699.P3), filed Jun. 26, 2003, both applications incorporated by reference herein to the extent the applications are not inconsistent with this disclosure.

While the processes described above may increase the removal rate, the remaining profile of the substrate may be improved to present a flatter remaining profile before a second polishing process, such as a residual removal process. It is believed that the pad conditioning regime presently used may be improved to enable a higher average removal rate and to selectively condition the processing surface of a pad.

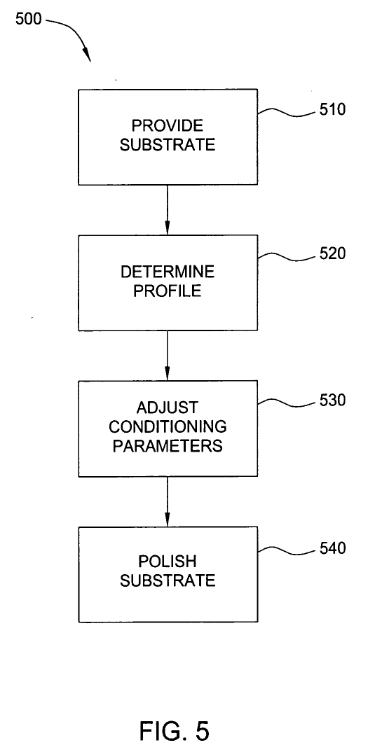

FIG. 5 is one embodiment of a polishing method 500 configured to enhance removal rate and/or control the removal of conductive material from the substrate. In one embodiment, the polishing method 500 enables selective conditioning on localized areas of the processing surface of the pad to restore optimum polishing qualities of the pad. In another embodiment, the polishing method 500 enables selective control and/or enhancement of an electrical characteristic such as a resistance profile of the processing surface of the processing pad, a conductivity profile of the processing surface of the processing pad, or combinations thereof. Thus, electrical contact between the conductive material on the substrate and the processing surface is improved.

In step 510, a substrate is provided having conductive material deposited thereon. The conductive material may be copper containing materials, tungsten containing materials, or any conductive metal used in the industry to produce electronic devices. At step 520, an incoming or pre-polish profile determination is made, for example by measuring the thickness of materials over portions of the substrate. The profile determination may include determining the thickness profile of a conductive material across the surface of the substrate. A metric indicative of thickness may be provided by any device or devices designed to measure film thickness of semiconductor substrates. Exemplary non-contact devices include i SCAN™ and i MAP™ available from Applied Materials, Inc. of Santa Clara, California, which scan and map the substrate, respectively.

At step 530, conditioning parameters are adjusted in response to the profile determination of step 520. Conditioning parameters include one or more of the conditioning head sweep range, denoted as arrow 410 (FIG. 4) above, a pressure or downforce applied to a conditioning element during conditioning, a rotational speed or RPM applied to a conditioning element, and a conditioning head sweep frequency. One or more of the conditioning parameters may be adjusted alone, or in combination with at least one other conditioning parameter. At step 540, the substrate is polished while conditioning the conductive pad in situ using the conditioning parameters of step 530. In this step, the substrate is brought into contact with a conductive polishing pad, more particularly, the conductive material on the substrate is brought into contact with the upper surface of the conductive polishing pad. The conductive polishing pad is rotated relative to the substrate, which is also rotated. In one embodiment in reference to FIG. 4, the conditioning head 300, the carrier head 105, and the conductive processing surface 225, coupled to the pad assembly 200 and platen 255 (not shown), are rotated counterclockwise. Other embodiments are contemplated where the rotational direction of the pad, the carrier head 105, and the conditioning head 300 may be different. An electrolyte containing passivation agents is flowed onto the pad and electrical power is applied to portions of the pad to facilitate anodic dissolution of the conductive material on the substrate. The electrical power may be pulsed as described above to facilitate enhanced passivation of the exposed conductive material.

While the conditioning parameters disclosed herein have been exemplarily described in an in situ process, the embodiments are not limited to this disclosure. In one embodiment, the conditioning parameters may be adjusted and the pad may be conditioned before or after a polishing process to condition the processing surface of the pad while foregoing the conditioning process during polishing. In other embodiments, the pad is conditioned in situ, and before or after the polishing process to prepare the processing surface for a subsequent polishing process.

If the substrate profile determination of step 520 indicates the conductive material is thicker on the edge than in the center, removal of this material may cause the polishing potential to diminish in portions of the processing surface of the pad that are in contact with the edge of the substrate. This local diminutive loss in removal rate may inhibit planarization of the conductive material on the substrate and detrimentally affect removal of conductive material from the substrate. Thus, preferentially conditioning the diminished portions of the processing surface restores the local loss in removal rate and/or increases the removal rate. For example, if the edge of the substrate is in contact with a perimeter portion of the processing surface of a circular conductive pad relative to a center portion of the processing surface of the circular conductive pad, the conditioning parameters may be adjusted to enhance conditioning of the perimeter portion of the processing surface of the circular conductive pad. In this instance, parameters such as conditioning element downforce could be increased on the perimeter portion and/or sweep frequency could be optimized by stopping the conditioning head from its sweep for a time to allow the conditioning element to have a dwell time on the perimeter before returning to its sweep. In this example, the increased pressure and/or the dwell time on the perimeter of the circular pad will increase the performance of the processing surface of the pad, thereby positively affecting removal rate.

In other embodiments, sweep frequency of the conditioning head and conditioning element may be adjusted. The sweep frequency may be adjusted to condition portions of the processing surface of the pad more aggressively on portions of the processing surface where localized loss of polishing potential is determined. For example, the sweep frequency could be based in part on the rotational speed of a circular conductive pad. In this example, the geometry and RPM of the pad may necessitate a higher or lower sweep frequency based on the profile determination and areas of contact between the substrate and the conductive pad. In one embodiment, the sweep frequency may be between about 5 sweeps/minute to about 20 sweeps/minute, for example between about 8 sweeps/minute to about 14 sweeps/minute, such as about 10 sweeps/minute.

In another embodiment, the sweep range may be adjusted by varying the sweep range across the processing surface of a circular conductive pad. For example, the center of a circular conductive pad may be prone to a greater localized loss of polishing potential relative to the perimeter of the circular conductive pad, thus inhibiting planarization in the center portion. In this instance, the sweep range may be varied from a full radial sweep to a three quarter sweep wherein the sweep range conditions from about the center of the pad to about three-quarters of the radius from the center. In this example, the remaining quarter of the radius of the pad will not be conditioned. A three quarter sweep may be used inversely if the perimeter of the circular pad exhibits decreased planarization potential relative to the center portion, thus conditioning the perimeter and not conditioning a portion of the pad near the center of the pad. The sweep range adjustment is not limited to the fraction described and may be any fraction depending on conditioning needs of the pad.

Other embodiments may combine a sweep range adjustment with the rotational motion of the pad, wherein the sweep range is a fractional range for any number of pad revolutions. The sweep range may be fractional for a desired integer of pad RPM and then a full sweep range is resumed for another desired integer of pad RPM. For example, if a greater localized loss of polishing potential is determined on the perimeter of the pad relative to the center, the center may need less conditioning than the perimeter. Thus, a half-sweep could be implemented between the perimeter of the pad and approximately half of the radius from the perimeter. This half-sweep may continue, for example, for about 5 to 10 revolutions of the pad. At every sixth or eleventh revolution, respectively, a full sweep may be resumed to condition the half radius of the pad in the center. The full sweep may be continued for any desired integer of pad RPM and the half-sweep may be resumed.

Conditioning element RPM may be adjusted to provide enhanced conditioning to various portions of the processing surface of a conductive polishing pad. In one embodiment, the conditioning element RPM may be set at some static RPM during conditioning. In one embodiment, the conditioning element RPM is between about 30 RPM to about 100 RPM, for example, between about 40 RPM to about 70 RPM. In other embodiments, the conditioning parameters may be adjusted as described above, and the conditioning element RPM may be varied. For example, the conditioning element RPM may be increased when the conditioning head is conditioning the perimeter portion of the pad, and decreased when conditioning the center portion. In this embodiment, the perimeter may be conditioned more aggressively than the center portion. If the center portion needs more aggressive conditioning than the perimeter portion, the conditioning element RPM could be higher when conditioning the center relative to the perimeter.

Conditioning head downforce may also be adjusted. In one embodiment, the downforce applied to the conditioning element relative the pad is static in a range between about 0.7 psi to about 2.0 psi, for example between about 1.0 psi to about 1.7 psi. In other embodiments, the conditioning parameters may be adjusted as described above, and the downforce may be varied. For example, the downforce may be increased when the conditioning head is conditioning the perimeter portion of the processing surface of the pad, and decreased when conditioning the processing surface of the center portion. In this embodiment, the perimeter may be conditioned more aggressively than the center portion. If the center portion needs more aggressive conditioning than the perimeter portion, the downforce could be higher when conditioning the center relative to the perimeter.

Experiments with substrates having a greater thickness of conductive material on the edge relative the center have been tested and using the prior conditioning regime yielded a total removal of conductive material from the substrate averaging between about 1550Å and about 1850Å. Subsequent substrates with similar profiles were polished using the conditioning regime described herein which yielded unexpected results of an increase in average total removal of greater than about 600Å. For example, the average removal rate using embodiments described herein yielded a total removal averaging between about 2350Å to about 2900Å.

While the conditioning methods disclosed herein have been exemplarily described conditioning a conductive pad, the invention is not limited to conductive pads as the processing surface of non-conductive pads may benefit from the conditioning method. Further, as the methods disclosed herein have been exemplarily described with a circular pad, the invention is not limited to this disclosure and may be used for example, on a linear polishing system, such as an endless belt, an apparatus using a pad configured to advance across a platen from a supply roll to a take up roll, or any apparatus for polishing substrates using a polishing pad. Other and further embodiments of the invention may be devised without departing from the basic scope thereof, and the scope thereof is determined by the claims that follow.

1. A method of processing a semiconductor substrate, comprising:
determining an incoming thickness profile of the substrate;
setting conditioning parameters in response to the thickness profile; and
conditioning a processing surface of a polishing pad using the conditioning parameters.

2. The method of claim 1, wherein the determining step further comprises:
determining the thickness profile of a conductive material across a surface of the substrate.

3. The method of claim 1, wherein the setting step further comprises:
setting at least one of a conditioning head sweep range, a conditioning head sweep frequency, a pressure applied to a conditioning element, a rotational speed applied to a conditioning element, and combinations thereof.

4. The method of claim 1, wherein the setting step further comprises:
setting a conditioning head sweep range to a full radial sweep range.

5. The method of claim 1, wherein the setting step further comprises:
setting a conditioning head sweep range to a fraction of a full radial sweep range.

6. The method of claim 1, wherein the setting step further comprises:
setting a conditioning head sweep frequency between about 5 sweeps/minute to about 20 sweeps/minute.

7. The method of claim 1, wherein the setting step further comprises:
setting a pressure applied to the conditioning element between about 0.7 psi to about 2.0 psi.

8. The method of claim 1, wherein the setting step further comprises:
setting a rotational speed applied to the conditioning element between about 30 RPM to about 100 RPM.

9. The method of claim 1, further comprising:
polishing the substrate during conditioning.

10. The method of claim 1, wherein the conditioning of the processing surface is done before a polishing process.

11. The method of claim 1, wherein the processing surface of the polishing pad is conductive.

12. A method of processing a semiconductor substrate, comprising:
determining a metric indicative of an incoming thickness profile of a conductive material on the substrate; and
changing an electrical property on a processing surface of a polishing pad in response to the metric.

13. The method of claim 12, wherein the processing surface of the polishing pad is conductive.

14. The method of claim 12, wherein the changing step further comprises:
setting one or more conditioning parameters in response to the metric;
processing the substrate against the processing surface of the polishing pad; and
conditioning the processing surface using the conditioning parameters.

15. The method of claim 12, wherein the processing surface of the polishing pad is conductive.

16. The method of claim 12, wherein the conductive material includes a copper containing material.

17. The method of claim 12, wherein the setting step includes at least one of adjusting a conditioning head sweep range, adjusting a conditioning head sweep frequency, adjusting a pressure applied to a conditioning element, adjusting a rotational speed applied to a conditioning element, and combinations thereof.

18. The method of claim 17, wherein the conditioning head sweep range is a full radial sweep range.

19. The method of claim 17, wherein the conditioning head sweep range is a fraction of a full radial sweep range.

20. The method of claim 17, wherein the conditioning head sweep frequency is between about 5 sweeps/minute to about 20 sweeps/minute.

21. The method of claim 17, wherein the pressure applied to the conditioning element is varied or static, the pressure between about 0.7 psi to about 2.0 psi.

22. The method of claim 17, wherein the rotational speed applied to the conditioning element is between about 30 RPM to about 100 RPM.

23. A method of processing a semiconductor substrate, comprising:
determining an incoming thickness profile of a conductive material on the substrate;
setting one or more conditioning parameters based on the thickness profile;
processing the substrate against a polishing surface of a polishing pad to perform a first polishing process; and
conditioning the processing surface using the conditioning parameters while performing the first polishing process.

24. The method of claim 23, wherein the setting step includes adjusting a conditioning head sweep range, a conditioning head sweep frequency, a pressure applied to a conditioning element, a rotational speed applied to a conditioning element, and combinations thereof.

25. The method of claim 23, wherein the one or more conditioning parameters includes a conditioning head sweep range at a full radial sweep.

26. The method of claim 23, wherein the one or more conditioning parameters includes a pressure applied to a conditioning element between about 0.7 psi to about 2.0 psi.

27. The method of claim 23, wherein the one or more conditioning parameters includes a rotational speed applied to a conditioning element between about 30 RPM to about 100 RPM.

28. The method of claim 23, further comprising:
conditioning the processing surface using the conditioning parameters before performing the first polishing process.
